(19) United States
(12) Patent Application Publication
(10) Pub. No.: US 2024/0144008 A1
(43) Pub. Date: May 2, 2024

(54) LEARNING APPARATUS, LEARNING METHOD, AND NON-TRANSITORY COMPUTER-READABLE STORAGE MEDIUM

(71) Applicant: CANON KABUSHIKI KAISHA, Tokyo (JP)

(72) Inventor: Koichi TANJI, Kanagawa (JP)

(21) Appl. No.: 18/486,192

(22) Filed: Oct. 13, 2023

(30) Foreign Application Priority Data
Oct. 28, 2022 (JP) 2022-173654

(51) Int. Cl. G06N 3/08

(52) U.S. Cl. CPC G06N 3/08

(57) ABSTRACT

A learning apparatus comprises one or more hardware processors, and one or more memories storing one or more programs configured to be executed by the one or more hardware processors, the one or more programs including instructions for, performing learning of a second learning model having an arrangement that is at least partially the same as an arrangement of a first learning model by distillation learning using an output of the first learning model, and dynamically changing, during the learning of the second learning model, at least one of a parameter of the first learning model, the arrangement of the first learning model, a parameter of the second learning model, and the arrangement of the second learning model.

### BACKGROUND OF THE INVENTION

### Field of the Invention

The present invention relates to a technique for distillation learning of learning models.

### Description of the Related Art

In recent years, in the machine learning field, distillation learning has attracted attention (“Distilling the Knowledge in a Neural Network”, G. Hinton et al. (NIPS 2014)). In distillation learning, in general, an output of a large-scale, accurate teacher model is set as teacher data (soft target), and a more lightweight student model is learned using an error (soft target error) between an output of the student model and the soft target.

Learning indicates, in a case where, for example, a hierarchical neural network is used, sequentially, iteratively updating a weight coefficient and other parameters in the neural network by backpropagating, in the neural network, an error of an output value obtained as a result of forward propagation calculation.

Furthermore, teacher data is a desired output (a label value or a distribution thereof) for input data, and in the above-described learning, learning is performed using learning data formed from the input data and the teacher data.

A soft target in distillation learning is, for example, an output obtained by using a softmax function with temperature as the activation function of the output layer. The softmax function with temperature has a characteristic in which as the temperature rises, the output value of a class corresponding to a correct class decreases, and the output values of the remaining classes increase. Thus, the output values (information) of the classes other than the correct class contribute to learning more than in a case where normal teacher data (hard target) is used for learning.

Then, the soft target error indicates an error calculated between the soft target and an output of a student model. In general, cross-entropy is used for an error function.

The teacher model in distillation learning is generally a large-scale and accurate model, as compared with a student model, that outputs a soft target at the time of learning of the student model in distillation learning. Furthermore, the student model is generally a model more lightweight than the teacher model, and is generated by learning using a soft target error in distillation learning.

Conventionally, forming an efficient architecture by devising or searching the layer structure and connection state of a neural network to acquire a lightweight model has been considered (“Neural Architecture Search with Reinforcement Learning”, B. Zoph et al. (ICLR 2017)). Furthermore, methods such as a method of quantizing a weight coefficient as a parameter of a neural network into a small number of bits or a pruning method of deleting a layer or connection with a low degree of contribution are used.

On the other hand, distillation learning needs a learned model to be used as a teacher model. However, distillation learning has not only the advantage of obtaining a lightweight accurate model but also the advantage that cannot be obtained from a conventional method of acquiring a lightweight model such as the advantages of being able to obtain, by the regularization effect, a model that tends not to overfit and of being able to use non-teacher data for learning.

The advantage of the regularization effect and the use of non-teacher data is also effective in a case where the network size is not changed. In a case where the network size is not changed, there is proposed a method called Born Again (“Born-Again Neural Networks”, Tommaso Furlanello et al. (ICML2018)) as a method of using the advantage of distillation learning. In Born Again, models of the same scale are used as a teacher model and a student model to perform distillation learning. At this time, a random value is used as the initial value of the student model. Upon completion of distillation learning of the first student model, this model is used as a teacher model to perform distillation learning of another student model. A random value is used as the initial value for distillation learning of the other student model. In Born Again, distillation learning from the random value of the student model and an operation of replacing the teacher model and the student model are repeated a plurality of times, thereby performing distillation learning of a plurality of student models. Finally, an ensemble of the plurality of generated student models is used as a final learning model.

Born Again has the advantage of obtaining the effect of distillation learning even in a case where the network size is not changed but distillation learning of a plurality of student models needs to be performed from the random initial value and thus the cost for learning is high. When performing inference using a learned model, it is necessary to ensemble outputs of a plurality of student models, thereby increasing the implementation and calculation cost at the time of inference. Note that the inference indicates, in a case where target data is input to a learned model and, for example, the input data is to be classified into a given class, a step of acquiring the output result of the classification.

### SUMMARY OF THE INVENTION

The present invention provides a technique for advancing distillation learning of a student model more efficiently.

According to the first aspect of the present invention, there is provided a learning apparatus comprising: one or more hardware processors; and one or more memories storing one or more programs configured to be executed by the one or more hardware processors, the one or more programs including instructions for: performing learning of a second learning model having an arrangement that is at least partially the same as an arrangement of a first learning model by distillation learning using an output of the first learning model; and dynamically changing, during the learning of the second learning model, at least one of a parameter of the first learning model, the arrangement of the first learning model, a parameter of the second learning model, and the arrangement of the second learning model.

According to the second aspect of the present invention, there is provided a learning method comprising: performing learning of a second learning model having an arrangement that is at least partially the same as an arrangement of a first learning model by distillation learning using an output of the first learning model; and dynamically changing, during the learning of the second learning model, at least one of a parameter of the first learning model, the arrangement of the first learning model, a parameter of the second learning model, and the arrangement of the second learning model.

According to the third aspect of the present invention, there is provided a non-transitory computer-readable storage medium storing a computer program for causing a computer to function as: a learning unit configured to perform learning of a second learning model having an arrangement that is at least partially the same as an arrangement of a first learning model by distillation learning using an output of the first learning model; and a control unit configured to dynamically change, during the learning of the second learning model, at least one of a parameter of the first learning model, the arrangement of the first learning model, a parameter of the second learning model, and the arrangement of the second learning model.

Further features of the present invention will become apparent from the following description of exemplary embodiments with reference to the attached drawings.

### BRIEF DESCRIPTION OF THE DRAWINGS

FIG. 1 is a block diagram showing an example of the functional arrangement of a learning apparatus;

FIG. 2 is a flowchart illustrating distillation learning of a student model;

FIG. 3 is a flowchart illustrating details of processing in step S104;

FIG. 4 is a schematic view of processing according to the flowchart shown in FIG. 2;

FIG. 5 is a view for explaining distillation learning according to a conventional technique;

FIG. 6A is a graph for explaining processing in step S201;

FIG. 6B is a graph for explaining the processing in step S201;

FIG. 6C is a graph for explaining the processing in step S201;

FIG. 6D is a graph for explaining the processing in step S201;

FIG. 7A is a graph schematically showing the state of a temperature fluctuation of a softmax function with temperature;

FIG. 7B is a graph schematically showing the state of a temperature fluctuation of a softmax function with temperature;

FIG. 7C is a graph schematically showing the state of a temperature fluctuation of the softmax function with temperature;

FIG. 7D is a graph schematically showing the state of a temperature fluctuation of the softmax function with temperature;

FIG. 8 is a view schematically showing a step of applying a fluctuation to the model arrangement of each of a teacher model and a student model;

FIG. 9 is a view schematically showing a step of generating a plurality of student models by self-distillation learning;

FIG. 10 is a view for explaining a case where self-distillation learning of a student model is performed by applying a fluctuation to an image as learning target data to be input to the student model in learning of the student model; and

FIG. 11 is a block diagram showing an example of the hardware arrangement of a computer apparatus applicable to a learning apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### [First Embodiment]

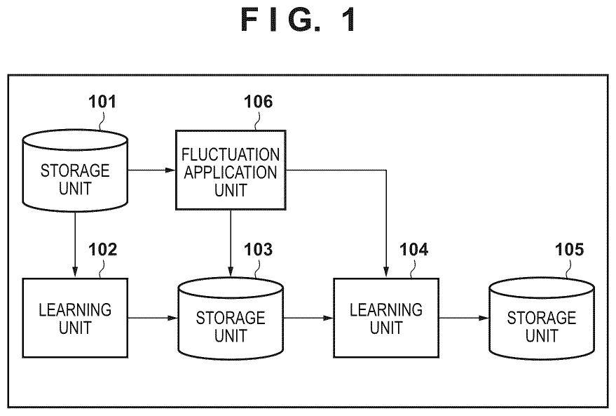

This embodiment will describe a case where in distillation learning, a softmax function with temperature is used as the activation function of the final output layer of each of a teacher model and a student model to perform self-distillation learning of the student model by applying a fluctuation to a temperature of the softmax function with temperature. First, an example of the functional arrangement of a learning apparatus according to this embodiment will be described with reference to a block diagram shown in FIG. 1.

A storage unit 101 stores learning data to be used for distillation learning. The learning data includes learning target data and teacher data corresponding to the learning target data. The learning target data may be, for example, still image data, moving image data, or audio data. The teacher data is data for specifying a class in the learning target data.

A learning unit 102 performs learning of a teacher model using the learning data stored in the storage unit 101. For the teacher model, a Convolutional Neural Network (CNN) including a convolution layer, a pooling layer, and a fully-connected layer, which is an example of a hierarchical neural network, is used. A softmax function with temperature is used as the activation function of the final output layer of the teacher model. Upon completion of learning of the teacher model, the learning unit 102 stores the learned teacher model in a storage unit 103.

A learning unit 104 performs learning of a student model by distillation learning using the learning target data included in the learning data stored in the storage unit 101 and a soft target as an output of the teacher model stored in the storage unit 103. As the student model, a model having an arrangement that is at least partially the same as that of the teacher model is used. That is, the student model may be a model having the same arrangement as that of the teacher model or a model having an arrangement that is partially the same as that of the teacher model. In either case, a Convolutional Neural Network (CNN) including a convolution layer, a pooling layer, and a fully-connected layer, which is an example of a hierarchical neural network, is also used for the student model. In addition, a softmax function with temperature is used as the activation function of the final output layer of the student model. Upon completion of learning of the student model, the learning unit 104 stores the learned student model in a storage unit 105.

A fluctuation application unit 106 controls a fluctuation to be applied to the overall system. In this embodiment, the fluctuation application unit 106 applies a Gaussian fluctuation with a constant average temperature and standard deviation to the temperature of each of the softmax function with temperature used as the activation function of the final output layer of the teacher model and the softmax function with temperature used as the activation function of the final output layer of the student model, thereby dynamically changing the temperature.

That is, the fluctuation application unit 106 sets, as “the temperature (teacher temperature) of the softmax function with temperature used as the activation function of the final output layer of the teacher model”, a random number generated in accordance with the Gaussian distribution with a constant average temperature and standard deviation every time the number of times of learning of the student model increases by LN (LN is an arbitrary natural number, and may be a variable or a fixed value). This can dynamically change the teacher temperature in learning of the student model (during learning).

Similarly, the fluctuation application unit 106 sets, as “the temperature (student temperature) of the softmax function with temperature used as the activation function of the final output layer of the student model”, a random number generated in accordance with the Gaussian distribution with a constant average temperature and standard deviation every time the number of times of learning of the student model increases by LN. This can dynamically change the student temperature in learning of the student model (during learning).

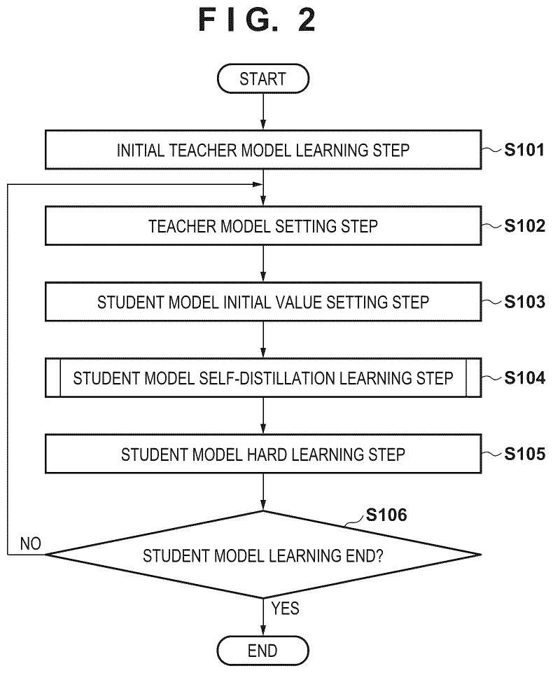

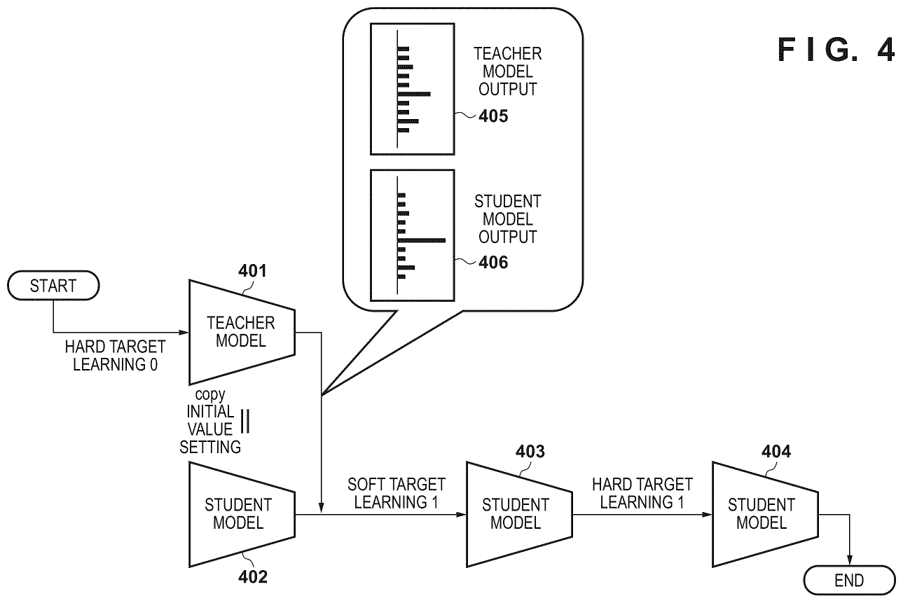

Next, distillation learning of a student model by the learning apparatus according to this embodiment will be described with reference to a flowchart shown in FIG. 2. FIG. 4 is a schematic view of processing according to the flowchart shown in FIG. 2.

In step S101, the learning unit 102 performs learning of a teacher model using the learning data stored in the storage unit 101. The initial values of the parameters (the weight coefficient and the like) of the teacher model are not limited to specific values and may be set randomly. Alternatively, in a case where there is an existing model suitable for a teacher model, the parameters of the model may be used as the initial values. As shown in FIG. 4, with learning processing (hard target learning 0) by the learning unit 102, a teacher model 401 is generated. Upon completion of learning of the teacher model, the learning unit 102 stores the learned teacher model in the storage unit 103.

In step S102, the learning unit 104 reads out the learned teacher model stored in the storage unit 103, thereby making it possible to perform inference using the learned teacher model. In step S103, the learning unit 104 sets initial values in the parameters (the weight coefficient and the like) of a student model. The parameters of the learned teacher model are set as the initial values of the parameters of the student model. In the example shown in FIG. 4, the parameters of the teacher model 401 are set as the initial values of the parameters of a student model 402.

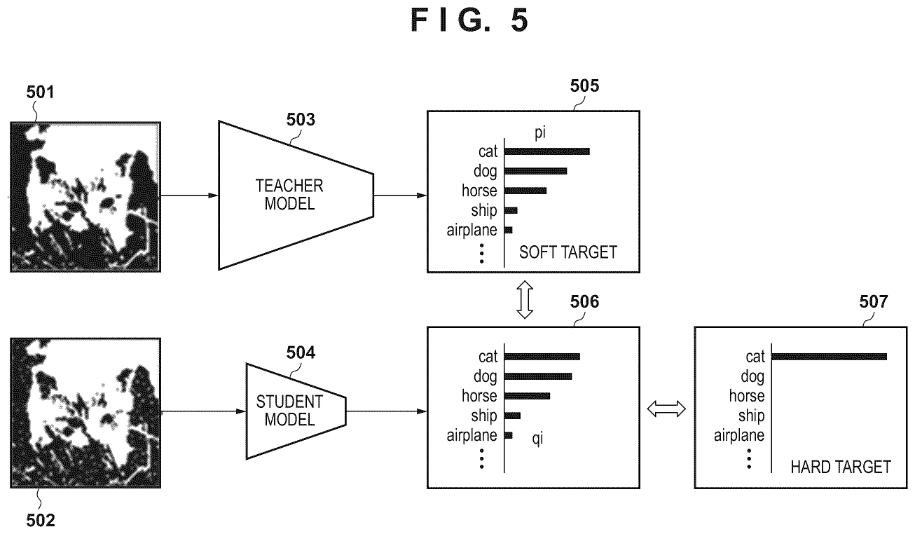

In step S104, learning of the student model is performed by distillation learning using the output of the teacher model. In the example shown in FIG. 4, self-distillation learning (soft target learning 1) of the student model 402 is performed using the output of the teacher model 401, thereby generating a student model 403. Prior to a description of self-distillation learning of the student model according to this embodiment, distillation learning as a conventional technique will be described with reference to FIG. 5.

An image 501 is learning target data to be input to a teacher model 503, and an image 502 is learning target data to be input to a student model 504. Both the images 501 and 502 are images of a cat as an animal. In general, as a teacher model, a large-scale model such as Alexnet (Krizhevsky, A., Sutskever, I., and Hinton, G. E. “ImageNet classification with deep convolutional neural networks” NIPS, pp. 1106-1114, 2012.) or VGG (K. Simonyan and A. Zisserman. “Very deep convolutional networks for large-scale image recognition” ICLR, 2015.) is used. On the other hand, as a student model, a more lightweight model is generally used to reduce the implementation cost and the calculation cost at the time of inference.

The teacher model 503 to which the image 501 has been input as the learning target data outputs a distribution (soft target) 505 of output values for respective classes (the likelihoods of the classes). p1 represents the likelihood corresponding to “cat” as the first class, p2 represents the likelihood corresponding to “dog” as the second class, and pi represents the likelihood corresponding to the ith class. The distribution of the output values in a case where the softmax function is used as the activation function has the characteristic in which the output value (in this example, the likelihood corresponding to the class “cat”) of the class corresponding to the correct class is close to 1 and the output values of the remaining classes are close to 0. If softmax_i represents the output value (likelihood) corresponding to the ith class, the softmax function is given by:

$$softmax\_i = \frac{exp ( {u}_{i} )}{{\sum }_{j} exp ( {u}_{j} )} \qquad ( 1 )$$

where uᵢ represents an input value to the softmax function corresponding to the ith class, and uⱼ represents an input value to the softmax function corresponding to the jth class. The range of the variable j in equation (1) is 1 to the total number of classes.

However, in distillation learning, since such function that the distribution of the output values is smoother, such as the softmax function with temperature, is used as the activation function, the output values other than the output value (in this example, the likelihood corresponding to “cat”) of the class corresponding to the correct class have relatively large values. If T_softmax_i represents the output value (likelihood) corresponding to the ith class when T represents a set temperature, the softmax function with temperature is given by:

$$T\_softmax \_i = \frac{exp ( {u}_{i} / T )}{{\sum }_{j} exp ( {u}_{j} / T )} \qquad ( 2 )$$

where uᵢ represents the input value to the softmax function with temperature corresponding to the ith class, and uⱼ represents the input value to the softmax function with temperature corresponding to the jth class. The range of the variable j in equation (2) is 1 to the total number of classes. The output value (likelihood) pᵢ of the teacher model is obtained as T_softmax_i using equation (2) above.

Therefore, the output value (in this example, the distribution of Pᵢ) of the softmax function with temperature includes information such as the similarity to the correct class not only in information of the class corresponding to the correct class but also in information of the remaining classes, and contributes to learning.

The student model 504 to which the image 502 has been input as the learning target data outputs a distribution 506 of the output values for the respective classes (the likelihoods of the classes). q1 represents the likelihood corresponding to “cat” as the first class, q2 represents the likelihood corresponding to “dog” as the second class, and qi represents the likelihood corresponding to the ith class.

In general, if, for example, the softmax function with temperature is used as the activation function of each of the teacher model and the student model, the temperature equal to the teacher temperature is applied to the student temperature. In distillation learning, a soft target loss soft_target_loss is obtained from the output value (likelihood) pᵢ of the teacher model and the output value (likelihood) qᵢ of the student model by:

soft_target_loss=−Σᵢpᵢlog(qᵢ) . . . (3)

The range of the variable i in equation (3) is 1 to the total number of classes. Furthermore, the output value (likelihood) qᵢ of the student model can be obtained by:

$${q}_{i} = \frac{exp ( {ν}_{i} / T )}{{\sum }_{j} exp ( {v}_{j} / T )} \qquad ( 4 )$$

where vᵢ represents the input value to the softmax function with temperature corresponding to the ith class in the student model, and vⱼ represents the input value to the softmax function with temperature corresponding to the jth class in the student model. The range of the variable j in equation (4) is 1 to the total number of classes.

Then, learning of the student model 504 is performed by updating the parameters of the student model 504 based on the soft target loss soft_target_loss obtained by equation (3). That is, the soft target loss soft_target_loss is fed back to learning of the student model 504.

Note that normal teacher data may further be used for learning of the student model 504. That is, the student model having undergone learning using the soft target may be relearned using the teacher data used at the time of learning of the teacher model.

FIG. 5 shows a distribution (hard target) 507 of the teacher data. In the distribution 507, only the likelihood of “cat” (this is the kth class) corresponding to the correct class is 1 and the likelihoods of the remaining classes are 0. In this case, a hard target loss hard_target_loss is obtained by:

hard_target_loss=−log(rₖ) . . . (5)

An output value rᵢ of the student model 504 can be obtained by:

$${r}_{i} = \frac{exp ( {v}_{i} )}{{\sum }_{j} exp ( {v}_{j} )} \qquad ( 6 )$$

where vᵢ represents the input value to the softmax function with temperature corresponding to the ith class in the student model 504, and vⱼ represents the input value to the softmax function with temperature corresponding to the jth class in the student model 504. The range of the variable j in equation (6) is 1 to the total number of classes. The hard_target_loss hard target loss is fed back to learning of the student model 504.

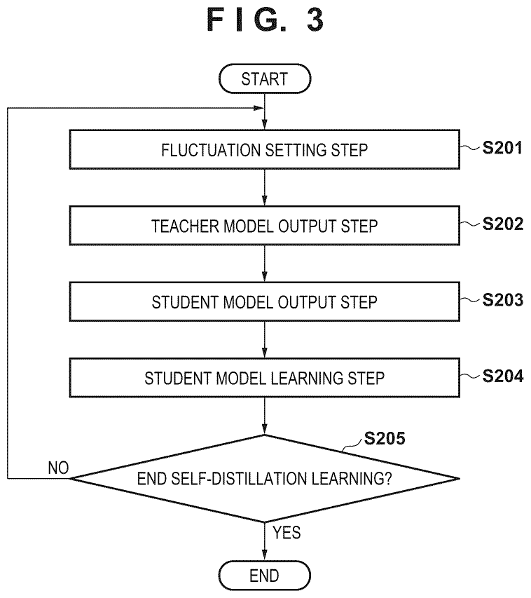

In distillation learning as the conventional technique described above, different models are used as a teacher model and a student model. However, in self-distillation learning according to this embodiment, the same models or models that are partially the same are used as a teacher model and a student model. However, in step S104, distillation learning is advanced by applying different fluctuations to the system with respect to the teacher model and the student model. The fluctuation applied to the system is, for example, a temperature fluctuation of the softmax function with temperature, a fluctuation that changes part of the arrangement of the model, or a fluctuation applied to input data to the model. In this embodiment, an example of self-distillation learning using the temperature fluctuation of the softmax function with temperature will be described with reference to a flowchart (a flowchart illustrating details of processing in step S104) shown in FIG. 3.

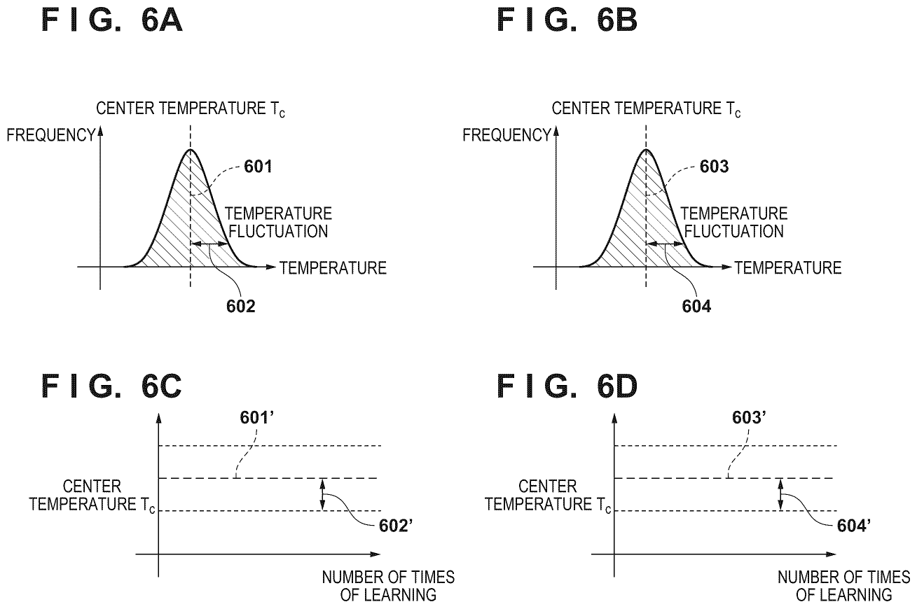

In step S201, the fluctuation application unit 106 sets a fluctuation applied to each of the teacher model and the student model. The processing in step S201 will be described by exemplifying FIGS. 6A to 6D.

FIG. 6A is a graph schematically showing the distribution of the teacher temperature set in the softmax function with temperature of the teacher model. The abscissa represents the teacher temperature and the ordinate represents a frequency. Reference numeral 601 denotes a center temperature Tc in the temperature fluctuation; and 602, a standard deviation σ_{T} of the temperature fluctuation. The temperature fluctuation is a temperature fluctuation based on the Gaussian distribution with the center temperature Tc as an average value and the standard deviation σ_{T}. When T represents the temperature, a probability distribution f_{T}(T) of the temperature is given by:

$${f}_{T} ( T ) = \frac{1}{\sqrt{2 π {σ}_{T}^{2}}} exp ( - \frac{{( T - {T}_{C} )}^{2}}{2 {σ}_{T}^{2}} ) \qquad ( 7 )$$

The fluctuation application unit 106 sets, as the teacher temperature, a random number (temperature T) generated in accordance with “the probability distribution f_{T}(T) as the Gaussian distribution with the center temperature Tc as an average value and the standard deviation σ_{T}” every time the number of times of learning of the student model increases by LN, as shown in FIG. 6C. This allows the fluctuation application unit 106 to apply a fluctuation to the teacher temperature in learning of the student model.

FIG. 6B is a graph schematically showing the distribution of the student temperature set in the softmax function with temperature of the student model. The abscissa represents the student temperature and the ordinate represents a frequency. Reference numeral 603 denotes a center temperature Tc in the temperature fluctuation; and 604, a standard deviation σ_{S} of the temperature fluctuation. The temperature fluctuation has the Gaussian distribution with the center temperature Tc as an average value and the standard deviation σ_{S}. When T represents the temperature, a probability distribution f_{S}(T) of the temperature is given by:

$${f}_{S} ( T ) = \frac{1}{\sqrt{2 π {σ}_{S}^{2}}} exp ( - \frac{{( T - {T}_{C} )}^{2}}{2 {σ}_{S}^{2}} ) \qquad ( 8 )$$

The fluctuation application unit 106 sets, as the student temperature, a random number (temperature T) generated in accordance with “the probability distribution f_{S}(T) as the Gaussian distribution with the center temperature Tc as an average value and the standard deviation σ_{S}” every time the number of times of learning of the student model increases by LN, as shown in FIG. 6D. This allows the fluctuation application unit 106 to apply a fluctuation to the student temperature in learning of the student model.

Therefore, in step S201, the fluctuation application unit 106 sets, as the teacher temperature, the random number (temperature T) generated in accordance with the probability distribution f_{T}(T). Furthermore, the fluctuation application unit 106 sets, as the student temperature, the random number (temperature T) generated in accordance with the probability distribution f_{S}(T).

Note that the example of applying a fluctuation to each of the teacher temperature and the student temperature has been explained. However, the present invention is not limited to application of a fluctuation to each of the teacher temperature and the student temperature and a fluctuation may be applied to only one of the temperatures.

In step S202, the learning unit 104 inputs the learning target data included in the learning data stored in the storage unit 101 to the teacher model 401 read out from the storage unit 103 in step S102, and obtains an output value 405 of the teacher model 401 as a soft target.

In step S203, the learning unit 104 inputs the learning target data (the same learning target data as that input to the teacher model in step S202) included in the learning data stored in the storage unit 101 to the student model 402 set, in step S103, with the initial values of the parameters, and obtains an output value 406 of the student model 402.

In step S204, the learning unit 104 obtains a soft target loss using the output value 405 as the soft target obtained in step S202 and the output value 406 obtained in step S203. Then, the learning unit 104 performs learning (soft target learning 1) of the student model by feeding back the obtained soft target loss to learning of the student model and updating the parameters of the student model.

The soft target loss becomes 0 in a case where there is no temperature fluctuation, and learning is not advanced. However, the soft target loss does not become 0 by applying a temperature fluctuation, and learning is advanced. In addition, by monitoring the value of the soft target loss, it is possible to further increase the set temperature fluctuation (for example, to be larger than the standard deviation) in a case where the value of the soft target loss is too small and advancement of learning is thus slow.

In step S205, the learning unit 104 determines whether the end condition of learning of the student model (self-distillation learning of the student model) is satisfied. The end condition is, for example, “the condition that the number of times of learning (the number of loops of steps S201 to S204) of the student model exceeds a threshold”, “the condition that the elapsed time since the start of learning of the student model exceeds a threshold”, “the condition that the change amount of the soft target loss is equal to or smaller than a predetermined amount”, or the like.

If, as a result of the determination processing, the end condition is satisfied, the process advances to step S105. On the other hand, if the end condition is not satisfied, the process advances to step S201. When the process advances to step S105, the student model 403 as the learning model learned by soft target learning 1 is obtained.

In step S105, the learning unit 104 inputs desired learning target data (learning target data to be relearned) among the learning target data included in the learning data to the student model 403 as the learning model learned by soft target learning 1, and obtains the output value of the student model 403 in accordance with equation (6) above. Then, the learning unit 104 performs learning (hard target learning 1) of the student model by obtaining a hard target loss in accordance with equation (5) above using the output value, feeding back the obtained hard target loss to learning of the student model, and updating the parameters of the student model. Note that hard target learning 1 is not essential, and may be eliminated, as appropriate.

In step S106, the learning unit 104 determines whether the end condition of learning of the student model (self-distillation learning of the student model) is satisfied. The end condition is, for example, “the condition that the number of times of learning (the number of loops of steps S102 to S105) of the student model exceeds a threshold”, “the condition that the elapsed time since the start of learning of the student model exceeds a threshold”, “the condition that the change amount of the hard target loss is equal to or smaller than a predetermined amount”, or the like. Furthermore, the end condition includes “a case where data representing that the performance of the student model evaluated based on the output value of the student model to which evaluation data has been input is equal to or higher than a predetermined value is obtained”.

If, as a result of the determination processing, the end condition is satisfied, the learning unit 104 stores a student model 404 as a learned learning model in the storage unit 105. The processing according to the flowchart shown in FIG. 2 ends. On the other hand, if the end condition is not satisfied, the process advances to step S102. As described above, according to this embodiment, it is possible to advance distillation learning of the student model more efficiently.

### [Second Embodiment]

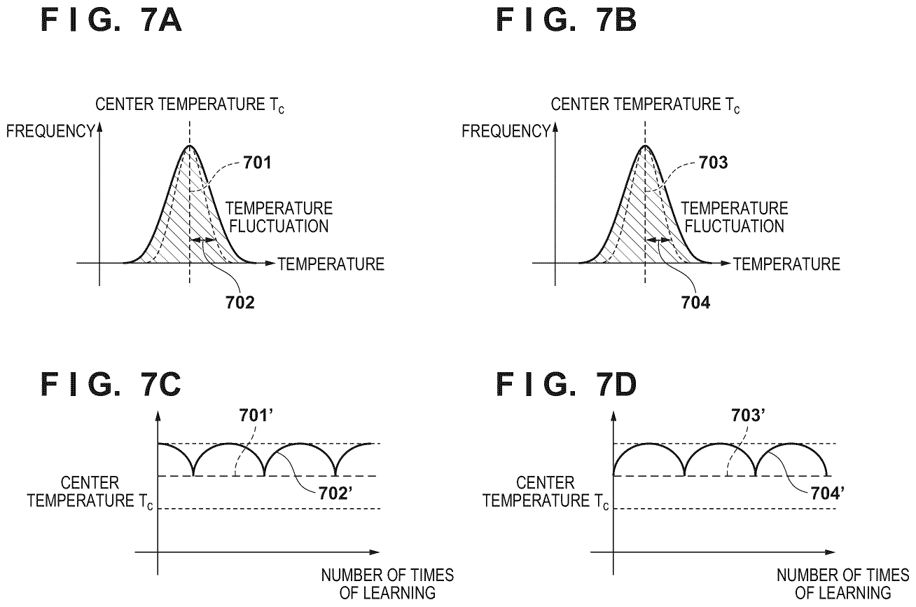

From this embodiment, the difference from the first embodiment will be described, and the remaining is assumed to be the same as in the first embodiment unless it is specifically stated otherwise below. This embodiment will describe a case of applying temperature fluctuations having different characteristics to a teacher model and a student model in a case where the softmax function with temperature is used as the activation function of the final output layer of each of the teacher model and the student model. This can advance self-distillation learning more efficiently. FIGS. 7A to 7D are graphs each schematically showing the state of the temperature fluctuation of the set softmax function with temperature according to this embodiment.

FIG. 7A is a graph schematically showing the distribution of the teacher temperature set in the softmax function with temperature of the teacher model. The abscissa represents the teacher temperature and the ordinate represents a frequency. Reference numeral 701 denotes a center temperature Tc in the temperature fluctuation; and 702, a standard deviation σ′_{T} of the temperature fluctuation. The temperature fluctuation is a temperature fluctuation based on the Gaussian distribution with the center temperature Tc as an average value and the standard deviation σ′_{T}. When T represents the temperature, a probability distribution f_{T}(T) of the temperature is given by:

$${f}_{T} ( T ) = \frac{1}{\sqrt{2 {πσ}_{T}^{′2}}} exp ( - \frac{{( T - {T}_{C} )}^{2}}{2 {σ}_{T}^{′2}} ) \qquad ( 9 )$$

Note that σ′_{T} varies in accordance with:

$${σ}_{T} ′ = {σ}_{T} \vert c o s ( \frac{2 π {ω}_{T} N}{{N}_{max}} ) \vert \qquad ( 10 )$$

where N represents the current number of times of learning, and ω_{T} represents the frequency of a variation to be given. Furthermore, Nmax represents the predetermined maximum value of the number of times of learning (the maximum number of times of learning), and σ_{T} represents the maximum value of the standard deviation σ′_{T}.

FIG. 7B is a graph schematically showing the distribution of the student temperature set in the softmax function with temperature of the student model. The abscissa represents the student temperature and the ordinate represents a frequency. Reference numeral 703 denotes a center temperature Tc in the temperature fluctuation; and 704, a standard deviation σ′_{S} of the temperature fluctuation. The temperature fluctuation is a temperature fluctuation based on the Gaussian distribution with the center temperature Tc as an average value and the standard deviation σ′_{S}. When T represents the temperature, a probability distribution f_{S}(T) of the temperature is given by:

$${f}_{S} ( T ) = \frac{1}{\sqrt{2 {πσ}_{S}^{′2}}} exp ( - \frac{{( T - {T}_{C} )}^{2}}{2 {σ}_{S}^{′2}} ) \qquad ( 11 )$$

Note that σ′_{S} varies in accordance with equation (12) below.

$${σ}_{S}^{′} = {σ}_{S} \vert sin ( \frac{2 π {ω}_{S} N}{{N}_{max}} ) \vert \qquad ( 12 )$$

where N represents the current number of times of learning, and ω_{S} represents the frequency of a variation to be given. Furthermore, Nmax represents the predetermined maximum value of the number of times of learning (the maximum number of times of learning), and σ_{S} as represents the maximum value of the standard deviation σ′_{S}.

FIG. 7C is a graph schematically showing the range (that is, the standard deviation σ′_{T} of the temperature fluctuation) of the temporal change (a change given in the step of learning) of the teacher temperature set in the softmax function with temperature of the teacher model. The abscissa represents the number of times of learning and the ordinate represents the teacher temperature. Reference numeral 701′ denotes the center temperature Tc; and 702′, a change of the magnitude of the standard deviation σ′_{T} of the temperature fluctuation.

FIG. 7D is a graph schematically showing the range (that is, the standard deviation σ′_{S} of the temperature fluctuation) of the temporal change (a change given in the step of learning) of the student temperature set in the softmax function with temperature of the student model. The abscissa represents the number of times of learning and the ordinate represents the student temperature. Reference numeral 703′ denotes the center temperature Tc; and 704′, a change of the magnitude of the standard deviation σ′_{S} of the temperature fluctuation.

Note that in this embodiment, the maximum values σ_{T} and σ_{S} of the standard deviation may be set to gradually decrease along with an increase in number of times of learning. There are various methods as a method of controlling each standard deviation, and the present invention is not limited to any specific control method. Furthermore, a parameter controlled in the probability distribution is not limited to the standard deviation.

As described above, in this embodiment, the phases of the set temperature fluctuations shift from each other with respect to the teacher model and the student model, and thus larger feedback can contribute to learning. This can advance self-distillation learning more efficiently.

### [Third Embodiment]

This embodiment will describe a case of applying a fluctuation to the arrangement (model arrangement) of each of a teacher model and a student model. As a fluctuation of the model arrangement, a case of dropping out the fully-connected layer of a CNN (a case of deleting (setting the value of the weight coefficient to 0) connections the number of which corresponds to a dropout rate among connections between neurons in the fully-connected layer) is assumed. However, the fluctuation applied to the model arrangement is not limited to this. Furthermore, the fully-connected layer is dropped out randomly on average. This can advance self-distillation learning more efficiently.

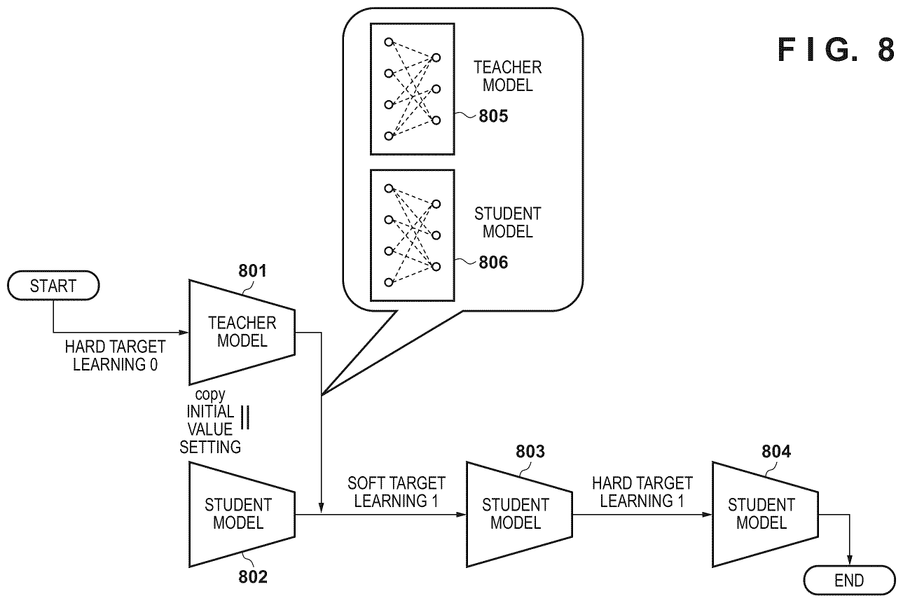

FIG. 8 is a view schematically showing a step of applying a fluctuation to the model arrangement of each of a teacher model and a student model. In the following description, an example of self-distillation learning using a fluctuation of the model arrangement will be described with reference to FIG. 8 together with the flowchart shown in FIG. 3.

In step S201, a fluctuation application unit 106 sets a fluctuation in each of a teacher model 801 having undergone hard target learning 0 and a student model 802 whose parameters have been initialized. More specifically, a dropout rate is set for each of the teacher model 801 and the student model 802. The fluctuation application unit 106 may set the same dropout rate or different dropout rates for the teacher model 801 and the student model 802. Furthermore, the fluctuation application unit 106 may change the dropout rate of the teacher model 801 and/or the dropout rate of the student model 802 in accordance with the number of times of learning. Note that the dropout rate may be decided in any manner and, for example, a random number (a real number within the range of 0 to 1) generated in accordance with the above probability distribution may be set as the dropout rate.

Then, if the fluctuation application unit 106 sets a dropout rate r1 (r1 is a real number satisfying 0<r1<1) for the teacher model 801, connections corresponding to (100×r1)% of the number of connections between neurons in the fully-connected layer of the teacher model 801 are set to 0 (dropped out). A fully-connected layer 805 is a fully-connected layer obtained as a result of performing dropout for the teacher model 801.

If the fluctuation application unit 106 sets a dropout rate r2 (r2 is a real number satisfying 0<r2<1) for the student model 802, connections corresponding to (100 ×r2)% of the number of connections between neurons in the fully-connected layer of the student model 802 are set to 0 (dropped out). A fully-connected layer 806 is a fully-connected layer obtained as a result of performing dropout for the student model 802.

In step S202, a learning unit 104 inputs learning target data included in learning data stored in a storage unit 101 to the teacher model 801 having undergone dropout, and obtains an output value of the teacher model 801 as a soft target.

In step S203, the learning unit 104 inputs the learning target data (the same learning target data as that input to the teacher model in step S202) included in the learning data stored in the storage unit 101 to the student model 802 having undergone dropout, and obtains an output value of the student model 802.

In step S204, the learning unit 104 obtains a soft target loss using the output value as the soft target obtained in step S202 and the output value obtained in step S203. Then, the learning unit 104 performs learning (soft target learning 1) of the student model by feeding back the obtained soft target loss to learning of the student model and updating the parameters of the student model.

Since the model arrangement of the teacher model and that of the student model are partially different from each other, the soft target loss does not become 0, and is fed back to learning of the student model (the parameters of the network are updated).

In step S205, the learning unit 104 determines whether the end condition of learning of the student model (self-distillation learning of the student model) is satisfied. If, as a result of the determination processing, the end condition is satisfied, the process advances to step S105. On the other hand, if the end condition is not satisfied, the process advances to step S201. When the process advances to step S105, a student model 803 as the learning model learned by soft target learning 1 is obtained.

Note that in step S105, the learning unit 104 inputs desired learning target data (learning target data to be relearned) among the learning target data included in the learning data to the student model 803 as the learning model learned by soft target learning 1, and obtains the output value of the student model 803 in accordance with equation (6) above. Then, the learning unit 104 performs learning (hard target learning 1) of the student model by obtaining a hard target loss in accordance with equation (5) above using the output value, feeding back the obtained hard target loss to learning of the student model, and updating the parameters of the student model. Note that hard target learning 1 is not essential, and may be eliminated, as appropriate.

In step S106, the learning unit 104 determines whether the end condition of learning of the student model (self-distillation learning of the student model) is satisfied. If, as a result of the determination processing, the end condition is satisfied, the learning unit 104 stores a learned student model 804 in a storage unit 105, and the processing according to the flowchart shown in FIG. 2 ends. On the other hand, if the end condition is not satisfied, the process advances to step S102.

As described above, since the model arrangement of the teacher model and that of the student model are partially different from each other, feedback is provided to learning. This can advance self-distillation learning more efficiently.

### [Fourth Embodiment]

This embodiment will describe a case of generating a plurality of student models by self-distillation learning. This can generate a plurality of student models by performing learning of the plurality of student models more efficiently.

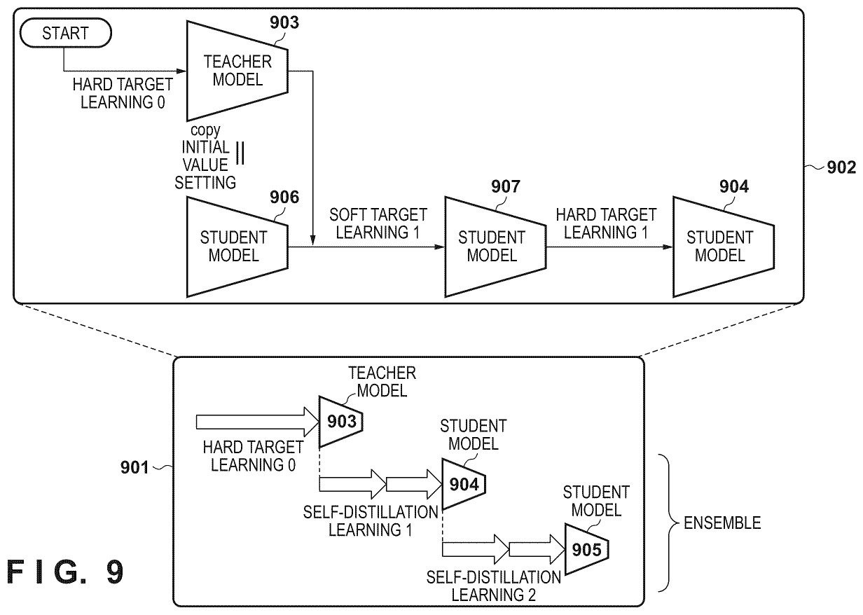

FIG. 9 is a view schematically showing a step of generating a plurality of student models by self-distillation learning. In the following description, a case of generating a plurality of student models by self-distillation learning will be described with reference to FIG. 9 together with the flowchart shown in FIG. 3. A step of generating a plurality of student models by self-distillation learning is schematically shown in a frame 901, and more details of a learning step of a student model 904 are shown in a frame 902.

Similar to the first embodiment, in step S201, a fluctuation application unit 106 sets, as a teacher temperature, a random number generated in accordance with a probability distribution f_{T}(T), and sets, as a student temperature, a random number generated in accordance with a probability distribution f_{S}(T).

In step S202, a learning unit 104 inputs learning target data included in learning data stored in a storage unit 101 to a teacher model 903 read out from a storage unit 103 in step S102, and obtains an output value of the teacher model 903 as a soft target. Note that the teacher model 903 is a model learned by hard target learning 0.

In step S203, the learning unit 104 inputs the learning target data (the same learning target data as that input to the teacher model in step S202) included in the learning data stored in the storage unit 101 to a student model 906 set, in step S103, with the initial values of the parameters, and obtains an output value of the student model 906.

In step S204, the learning unit 104 obtains a soft target loss using the output value as the soft target obtained in step S202 and the output value obtained in step S203. Then, the learning unit 104 generates a student model 907 by feeding back the obtained soft target loss to learning of the student model 906 and updating the parameters of the student model 906 (soft target learning 1).

In step S205, the learning unit 104 determines whether the end condition of learning of the student model is satisfied. If, as a result of the determination processing, the end condition is satisfied, the process advances to step S105. On the other hand, if the end condition is not satisfied, the process advances to step S201. When the process advances to step S105, the student model 907 as the learning model learned by soft target learning 1 is obtained.

Note that in step S105, the learning unit 104 inputs desired learning target data (learning target data to be relearned) among the learning target data included in the learning data to the student model 907 as the learning model learned by soft target learning 1, and obtains the output value of the student model 907 in accordance with equation (6) above. Then, the learning unit 104 performs learning (hard target learning 1) of the student model by obtaining a hard target loss in accordance with equation (5) above using the output value, feeding back the obtained hard target loss to learning of the student model, and updating the parameters of the student model. Note that hard target learning 1 is not essential, and may be eliminated, as appropriate.

In step S106, the learning unit 104 determines whether the end condition of learning of the student model (self-distillation learning of the student model) is satisfied. If, as a result of the determination processing, the end condition is satisfied, the learning unit 104 stores the learned student model 904 in a storage unit 105, and the processing according to the flowchart shown in FIG. 2 ends. On the other hand, if the end condition is not satisfied, the process advances to step S102.

As described above, the student model 904 is generated by self-distillation learning 1 using soft target learning 1 and hard target learning 1. Then, a student model 905 is generated by performing, for the student model set with the parameters of the student model 904 as initial values, soft target learning similar to self-distillation learning 1 and hard target learning similar to hard target learning 1 (these correspond to self-distillation learning 2). Learning of the student model 905 can advance learning more efficiently by setting the parameters of the student model 904 as initial values, as compared with learning using a random value as an initial value. If self-distillation learning is repeated N times, N student models are generated. At the time of performing inference, outputs of the N student models are ensembled.

### [Fifth Embodiment]

This embodiment will describe a case of applying a fluctuation to learning target data input to a student model or a teacher model in learning of the student model. This can advance self-distillation learning more efficiently.

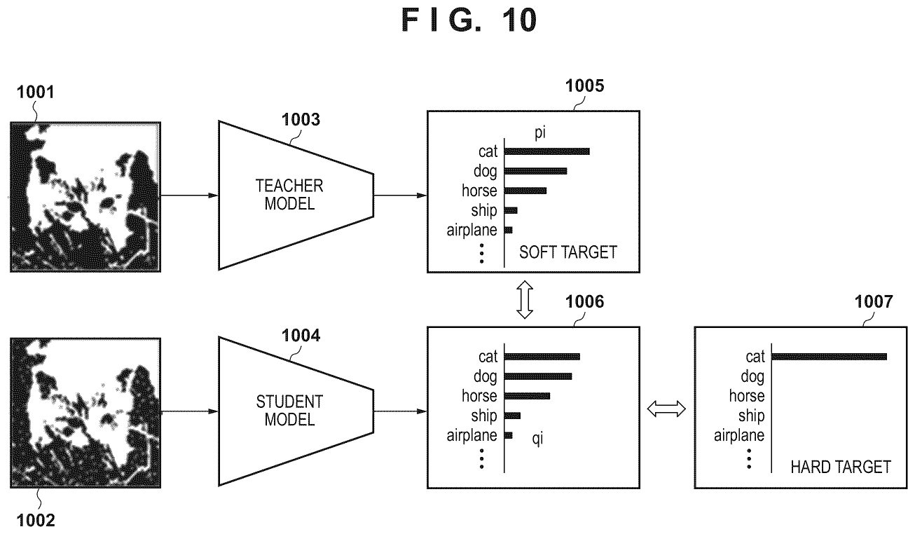

A case where a fluctuation is applied to an image as learning target data to be input to a student model to perform self-distillation learning of the student model in learning of the student model will be described with reference FIG. 10.

An image 1001 is an image of a cat as an animal, and is learning target data to be input to a teacher model 1003. An image 1002 is an image of a cat as an animal, and is learning target data to be input to a student model 1004. A fluctuation is applied to the pixel values of some or all of pixels in the image 1002. The applied fluctuation is based on the Gaussian distribution with a center pixel value I_{c} as an average value and a standard deviation σ_{SI}. When I represents a pixel value, a probability distribution f_{SI}(I) of the pixel value is given by:

$${f}_{SI} ( I ) = \frac{1}{\sqrt{2 π {σ}_{SI}^{2}}} exp ( - \frac{{( I - {I}_{C} )}^{2}}{2 {σ}_{SI}^{2}} ) \qquad ( 13 )$$

A fluctuation application unit 106 generates the image 1002 by setting, for each of some or all of the pixels in the image, as the pixel value of the pixel, a random number (pixel value I) generated in accordance with “the probability distribution f_{SI}(I) as the Gaussian distribution with the center pixel value I_{C} as an average value and the standard deviation σ_{SI}” every time the number of times of learning of the student model increases by LN. This allows the fluctuation application unit 106 to apply a fluctuation to the image to be input to the student model in learning of the student model. Note that in a case where the image is an RGB image, a fluctuation is applied to each of the R, G, and B pixel values.

Note that the teacher model 1003 and the student model 1004 shown in FIG. 10 are network models having arrangements that are at least partially the same. In this example, VGG is used for both the models. A case where a softmax function with temperature is used as the activation function of the final output layer of each of the teacher model and the student model will be described below.

The teacher model 1003 to which the image 1001 has been input outputs a distribution (soft target) 1005 of output values for respective classes (the likelihoods of the classes). On the other hand, the student model 1004 to which the image 1002 has been input outputs a distribution 1006 of output values for the respective classes (the likelihoods of the classes).

Then, similar to the first embodiment, a soft target loss soft_target_loss is obtained from the output value (likelihood) of the teacher model 1003 and the output value (likelihood) of the student model 1004. Similar to the first embodiment, learning (soft target learning) of the student model 1004 is performed by updating the parameters of the student model 1004 based on the soft target loss soft_target_loss. Even in a case where the teacher model and the student model have the same network arrangement and parameters, if input data are different, the soft target loss does not become 0, there is feedback to learning, and thus learning is advanced.

Then, similar to the first embodiment, desired learning target data (learning target data to be relearned) among learning target data included in learning data is input to the student model 1004 as the learning model learned by soft target learning, and the output value of the student model 1004 is obtained in accordance with equation (6) above. After that, learning (hard target learning) of the student model is performed by obtaining a hard target loss in accordance with equation (5) above using the output value, feeding back the obtained hard target loss to learning of the student model, and updating the parameters of the student model. Note that hard target learning is not essential, and may be eliminated, as appropriate.

As described above, if input data to the teacher model and the student model are partially different, feedback is provided to learning. This can advance self-distillation learning more efficiently.

The present invention aims at providing a method and apparatus that can perform distillation learning and inference at lower cost by performing self-distillation learning using a fluctuation in models of the same scale, and is applicable to any method or target as long as the aim is met.

In this embodiment, a fluctuation is applied to the pixel values of some or all of the pixels in the image 1002 input to the student model 1004, and no fluctuation is applied to the pixel values of some or all of the pixels in the image 1001 input to the teacher model 1003. The present invention, however, is not limited to this, and a fluctuation may be applied to the pixel values of some or all of the pixels in the image 1001.

Furthermore, this embodiment can be combined with one or more of the first to fourth embodiments. For example, while applying a fluctuation to the temperature (teacher temperature or student temperature), a fluctuation may be applied to an image to be input to the teacher model or the student model. In addition, for example, while applying a fluctuation to the arrangement of the teacher model or the student model, a fluctuation may be applied to an image to be input to the teacher model or the student model.

### [Sixth Embodiment]

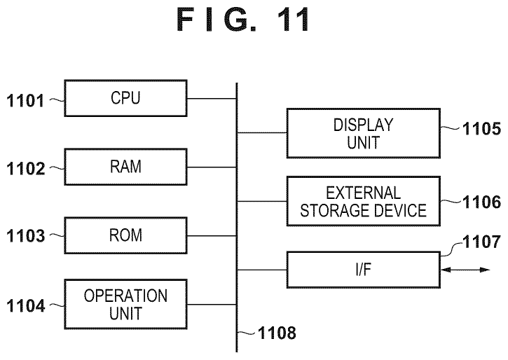

The functional units shown in FIG. 1 may be implemented by hardware, or functional units except for the storage units 101, 103, and 105 may be implemented by software (computer programs). In the latter case, a computer apparatus that can execute such computer programs can be applied to the above-described learning apparatus. An example of the hardware arrangement of the computer apparatus applicable to the learning apparatus will be described with reference to a block diagram shown in FIG. 11.

A CPU 1101 executes various kinds of processes using computer programs and data stored in a RAM 1102 and a ROM 1103. Thus, the CPU 1101 performs operation control of the overall computer apparatus, and also executes or controls various kinds of processes described as processes performed by the above-described learning apparatus.

The RAM 1102 includes an area used to store computer programs and data loaded from the ROM 1103 or an external storage device 1106, and an area used to store computer programs and data received from the outside via an I/F 1107. Furthermore, the RAM 1102 includes a work area used by the CPU 1101 to execute various kinds of processes. In this way, the RAM 1102 can appropriately provide various kinds of areas.

The ROM 1103 stores setting data of the computer apparatus, computer programs and data associated with activation of the computer apparatus, computer programs and data associated with the basic operation of the computer apparatus, and the like.

An operation unit 1104 is a user interface such as a keyboard, a mouse, or a touch panel. A user can input various kinds of instructions and data by operating the operation unit 1104. For example, the user can input information (a threshold, a center temperature, a center pixel value, a standard deviation, the maximum number of times of learning, and the like) explained as known information in the above description by operating the operation unit 1104.

A display unit 1105 includes a liquid crystal screen or a touch panel screen, and can display a processing result by the CPU 1101 as an image or characters. For example, the display unit 1105 can display, as images or characters, various kinds of information (a soft target loss, a hard target loss, a threshold, a center temperature, a center pixel value, a standard deviation, the maximum number of times of learning, and the like) associated with learning. This allows the user to input (adjust) parameters such as a threshold, a center temperature, a center pixel value, a standard deviation, and the maximum number of times of learning with reference to the result of learning displayed on the display unit 1105 by operating the operation unit 1104. Note that the display unit 1105 may be a projection apparatus such as a projector that projects images or characters.

The external storage device 1106 is a mass information storage device such as a hard disk drive device. The external storage device 1106 stores an Operating System (OS), and computer programs and data configured to cause the CPU 1101 to execute or control various kinds of processes described as processes to be performed by the above-described learning apparatus. The computer programs and data stored in the external storage device 1106 are loaded into the RAM 1102 as needed under the control of the CPU 1101 and processed by the CPU 1101. Note that the storage units 101, 103, and 105 shown in FIG. 1 can be implemented using memory devices such as the RAM 1102 and the external storage device 1106.

The I/F 1107 is a communication interface configured to perform data communication with an external apparatus. The CPU 1101, the RAM 1102, the ROM 1103, the operation unit 1104, the display unit 1105, the external storage device 1106, and the I/F 1107 are all connected to a system bus 1108. Note that the hardware arrangement shown in FIG. 11 is merely an example of the hardware arrangement of the computer apparatus applicable to the above-described learning apparatus, and can be modified/changed, as needed.

Numerical values, processing timings, processing orders, main constituents of processing, acquisition methods/transmission destinations/transmission sources/storage locations of data (information) used in the above-described embodiments are merely examples for a detailed explanation. The present invention is not intended to limit these to the examples.

Some or all of the above-described embodiments may be used in combinations as needed. Alternatively, some or all of the above-described embodiments may selectively be used.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-173654, filed Oct. 28, 2022, which is hereby incorporated by reference herein in its entirety.

What is claimed is:

1. A learning apparatus comprising:
one or more hardware processors; and
one or more memories storing one or more programs configured to be executed by the one or more hardware processors, the one or more programs including instructions for:
performing learning of a second learning model having an arrangement that is at least partially the same as an arrangement of a first learning model by distillation learning using an output of the first learning model; and
dynamically changing, during the learning of the second learning model, at least one of a parameter of the first learning model, the arrangement of the first learning model, a parameter of the second learning model, and the arrangement of the second learning model.

2. The apparatus according to claim 1, wherein, during the learning of the second learning model, a temperature of a softmax function with temperature as an activation function of a final output layer of the first learning model is dynamically changed.

3. The apparatus according to claim 2, wherein, during the learning of the second learning model, the temperature of the softmax function with temperature as the activation function of the final output layer of the first learning model is dynamically changed in accordance with a temperature fluctuation based on a Gaussian distribution.

4. The apparatus according to claim 3, wherein a parameter of the Gaussian distribution is dynamically changed in accordance with the number of times of learning of the second learning model.

5. The apparatus according to claim 1, wherein, during the learning of the second learning model, a connection between neurons in a fully-connected layer of the first learning model is dynamically changed.

6. The apparatus according to claim 1, wherein, during the learning of the second learning model, pixel values of some or all of pixels in an image to be input to the first learning model are dynamically changed.

7. The apparatus according to claim 1, wherein, during the learning of the second learning model, a temperature of a softmax function with temperature as an activation function of a final output layer of the second learning model is dynamically changed.

8. The apparatus according to claim 7, wherein, during the learning of the second learning model, the temperature of the softmax function with temperature as the activation function of the final output layer of the second learning model is dynamically changed in accordance with a temperature fluctuation based on a Gaussian distribution.

9. The apparatus according to claim 8, wherein a parameter of the Gaussian distribution is dynamically changed in accordance with the number of times of learning of the second learning model.

10. The apparatus according to claim 1, wherein, during the learning of the second learning model, a connection between neurons in a fully-connected layer of the second learning model is dynamically changed.

11. The apparatus according to claim 1, wherein, during the learning of the second learning model, pixel values of some or all of pixels in an image to be input to the second learning model are dynamically changed.

12. The apparatus according to claim 1, wherein the parameter of the first learning model is set as an initial value of the parameter of the second learning model.

13. The apparatus according to claim 1, wherein, using teacher data used at the time of learning of the first learning model, learning of the second learning model learned by the distillation learning is performed.

14. The apparatus according to claim 1, wherein, by the distillation learning using the output of the first learning model, learning of another second learning model set with the parameter of the second learning model learned by the learning is performed.

15. The apparatus according to claim 1, wherein the first learning model is a learned model.

16. A learning method comprising:
performing learning of a second learning model having an arrangement that is at least partially the same as an arrangement of a first learning model by distillation learning using an output of the first learning model; and
dynamically changing, during the learning of the second learning model, at least one of a parameter of the first learning model, the arrangement of the first learning model, a parameter of the second learning model, and the arrangement of the second learning model.

17. A non-transitory computer-readable storage medium storing a computer program for causing a computer to function as:
a learning unit configured to perform learning of a second learning model having an arrangement that is at least partially the same as an arrangement of a first learning model by distillation learning using an output of the first learning model; and
a control unit configured to dynamically change, during the learning of the second learning model, at least one of a parameter of the first learning model, the arrangement of the first learning model, a parameter of the second learning model, and the arrangement of the second learning model.
